(19) United States
(12) Patent Application Publication
(10) Pub. No.: US 2014/0320344 A1
(43) Pub. Date: Oct. 30, 2014

(54) TECHNIQUES FOR OPERATING PHASED ARRAY ANTENNAS IN MILLIMETERWAVE RADIO MODULES

(71) Applicant: QUALCOMM ATHEROS INCORPORATED, SAN JOSE, CA (US)

(72) Inventors: Amichai SANDEROVICH, Haifa (IL); Alon YEHEZKELY, Haifa (IL)

(21) Appl. No.: 14/325,346

(22) Filed: Jul. 7, 2014

Related U.S. Application Data
(63) Continuation-in-part of application No. 13/729,553, filed on Dec. 28, 2012.
(60) Provisional application No. 61/843,741, filed on Jul. 8, 2013.
(60) Provisional application No. 61/643,438, filed on May 7, 2012.

(51) Int. Cl. H01Q 3/26; H01Q 21/06

(52) U.S. Cl. CPC H01Q 3/2605; H01Q 21/061
USPC 342/372

(57) ABSTRACT

A method and apparatus for operating a plurality of radiating elements are provided. In one aspect, the method includes measuring a phase and a gain of each of the plurality of radiating elements; determining a feed gain and a feed phase for each of the plurality of radiating elements based on the measured phase and the measured gain of a respective radiating element; and setting independently each of the plurality of radiating elements based on the determined feed gain and the feed phase.

### CROSS REFERENCE TO RELATED APPLICATIONS

This application claims the benefit of U.S. Provisional Application No. 61/843,741 filed Jul. 8, 2013. This application is also a continuation-in-part of U.S. patent application Ser. No. 13/729,553 filed Dec. 28, 2012, now pending, which claims the benefit of U.S. Provisional Application No. 61/643,438, filed May 7, 2012.

### TECHNICAL FIELD

The invention relates generally to millimeter wave radio frequency (RF) systems and, more particularly, to operation of phased array antennas in such radio modules that to allow efficient signal propagation.

### BACKGROUND

The 60 GHz band is an unlicensed band which features a large amount of bandwidth and a large worldwide overlap. The large bandwidth means that a very high volume of information can be transmitted wirelessly. As a result, multiple applications, each requiring transmission of large amounts of data, can be developed to allow wireless communication around the 60 GHz band. Examples for such applications include, but are not limited to, wireless high definition TV (HDTV), wireless docking stations, wireless Gigabit Ethernet, and many others.

In order to facilitate such applications there is a need to develop integrated circuits (ICs) such as amplifiers, mixers, radio frequency (RF) analog circuits, and active antennas that operate in the 60 GHz frequency range. An RF system typically comprises active and passive modules. The active modules (e.g., a phased array antenna) require control and power signals for their operation, which are not required by passive modules (e.g., filters). The various modules are fabricated and packaged as radio frequency integrated circuits (RFICs) that can be assembled on a printed circuit board (PCB). The size of the RFIC package may range from several to a few hundred square millimeters.

In the consumer electronics market, the design of electronic devices, and thus the design of RF modules integrated therein, should meet the constraints of minimum cost, size, power consumption, and weight. The design of the RF modules should also take into consideration the current assembled configuration of electronic devices, and particularly handheld devices, such as laptop and tablet computers, in order to enable efficient transmission and reception of millimeter wave signals. Furthermore, the design of the RF module should account for minimal power loss of receive and transmit RF signals and for maximum radio coverage.

A schematic diagram of a RF module 100 designed for transmission and reception of millimeter wave signals is shown in FIG. 1. The RF module 100 includes an array of active antennas 110-1 through 110-N connected to a RF circuitry or IC 120. Each of the active antennas 110-1 through 110-N may operate as transmit (TX) and/or receive (RX) antennas. An active antenna can be controlled to receive/transmit radio signals in a certain direction, to perform beam forming, and to switch from receive to transmit modes. For example, an active antenna may be a phased array antenna in which each radiating element can be controlled individually and independently to enable the usage of beam-forming techniques.

In the transmit mode, the RF circuitry 120 typically performs up-conversion, using a mixer (not shown in FIG. 1), to convert intermediate frequency (IF) signals to radio frequency (RF) signals. Then, the RF circuitry 120 transmits the RF signals through the TX antenna according to the control signal. In the receive mode, the RF circuitry 120 receives RF signals through the active RX antenna and performs down-conversion, using a mixer, to IF signals using the local oscillator (LO) signals, and sends the IF signals to a baseband module (not shown in FIG. 1).

In both receive and transmit modes, the operation of the RF circuitry 120 is controlled by the baseband module using a control signal. The control signal is utilized for functions such as gain control, RX/TX switching, power level control, beam steering operations, and so on. In certain configurations, the baseband module also generates the LO and power signals and transfers such signals to the RF circuitry 120. The power signals are DC voltage signals that power the various components of the RF circuitry 120. Normally, the IF signals are also transferred between the baseband module and the RF circuitry 120.

In common design techniques, the array of active antennas 110-1 to 110-N are implemented on the substrate upon which the IC of the RF circuitry 120 is also mounted. An IC is fabricated on a multi-layer substrate and metal vias that connect between the various layers. The multi-layer substrate may be a combination of metal and dielectric layers and can be made of materials such as a laminate (e.g., FR4 glass epoxy, Bismaleimide-Triazine), ceramic (e.g., low temperature co-fired ceramic LTCC), polymer (e.g., polyimide), PTFE (Polytetrafluoroethylene) based compositions (e.g., PTFE/Ceramic, PTFE/Woven glass fiber), and Woven glass reinforced materials (e.g., woven glass reinforced resin), wafer level packaging, and other packaging, technologies and materials. The cost of the multi-layer substrate is a function of the area of the layer; the greater the area of the layer, the greater the cost of the substrate.

Antenna elements of the array of active antennas 110-1 to 110-N are typically implemented by having metal patterns in a multilayer substrate. Each antenna element can utilize several substrate layers. In conventional implementations for millimeter wave communications, antenna elements are designed to occupy a single side of the multi-layer substrate side. This is performed in order to allow the antenna radiation to properly propagate.

In conventional designs of RF systems, the active antennas 110-1 to 110-N are phased array. Phased array antennas provide the ability to focus the beam of many antenna elements in a specific direction. That is, the phased array antennas act as if they were a single antenna.

The connections between phased array antenna elements are commonly performed by using an adder component that joins the feeds from all antenna elements into a single feed. The adder component can function in various places along the feed. The feed path from the baseband to the RF module, as such the signal's frequency along the feed path can change from IF to RF frequency.

A conventional implementation of phased array typically includes an array of identical antenna elements. Each antenna element is independently controlled by an adjustable control that adjusts the feed of the antenna element to coordinate with the rest of the antenna elements. Therefore, the overall beam is focused on a specific direction or creates a specific beam shape.

Because the antenna elements are identical, the adjustable control is known to be optimal with independent control of phase for each element feed.

As shown in FIG. 2, conventional phased array antennas use identical elements 210-1 through 210-4 (hereinafter referred to individually as an element 210 or collectively as elements 210). The direction in which the signal is propagated yields approximately identical gain for each element 210, while the phases of the elements 210 are different.

In the very high frequencies, e.g. between 30 GHz and 300 GHz, conventional phased array antennas are implemented using the same principles as in lower frequencies.

There is a fundamental limit in very high frequencies to produce an antenna element with a close to omni-radiation pattern. This means that each element of a conventional phased-array antenna is characterized with a narrow beam width. For example, a patch antenna element having more than 4 dBi or a dipole over ground element having more than 2 dBi may not focus well. A conventional phased array antenna which having N identical elements with 10 log(N)+5 dBi gain results with a phased array which can be configured to focus well within the individual 5 dBi elements pattern.

The high frequency diffracted waves introduce more losses than low frequency transmissions. Therefore, the ability to efficiently transmit in all directions is an important design criterion for antenna arrays operating in high frequency. Thus, the conventional design of phased-array antennas is inefficient for transmission of mm-wave signals at, for example, the 60 GHz frequency band.

It would be therefore advantageous to provide a solution that improves the operation of phased-array antennas.

### SUMMARY

A summary of several example aspects of the disclosure follows. This summary is provided for the convenience of the reader to provide a basic understanding of such aspects and does not wholly define the breadth of the disclosure. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later. For convenience, the term some aspects may be used herein to refer to a single aspect or multiple aspects of the disclosure.

The disclosure relates in various aspects to a method for operating a plurality of radiating elements. In some implementations, the method includes measuring a phase and a gain of each of the plurality of radiating elements; determining a feed gain and a feed phase for each of the plurality of radiating elements based on the measured phase and the measured gain of a respective radiating element; and independently setting each of the plurality of radiating elements based on the determined feed gain and the feed phase.

The disclosure further relates in various aspects to an apparatus configured for communication. The apparatus comprises a plurality of radiating elements; and a processing system configured to: measure a phase and a gain of each of the plurality of radiating elements; determine a feed gain and a feed phase for each of the plurality of radiating elements based on the measured phase and gain of a respective radiating element; and independently set the feed gain and the feed phase of each of the plurality of radiating elements based on the determined feed gain and the feed phase.

Various aspects of the disclosure also provide an apparatus for operating a plurality of radiating elements. The apparatus comprises means for measuring a phase and a gain of each of the plurality of radiating elements; means for determining a feed gain and a feed phase for each of the plurality of radiating elements based on the measured phase and the measured gain of a respective radiating element; and means for independently setting each of the plurality of radiating elements based on the determined feed gain and the feed phase.

Various aspects of the disclosure further provide an access terminal that comprises a plurality of radiating elements; a processing system configured to: measure a phase and a gain of each of the plurality of radiating elements; determine a feed gain and a feed phase for each of the plurality of radiating elements based on the measured phase and the measured gain of a respective radiating element; independently set each of the plurality of radiating elements respective of the determined feed gain and the feed phase; and a transmitter configured to transmit signals via the set radiating elements.

Various aspects of the disclosure further provide a computer program product comprising a computer-readable medium. The computer-readable medium includes instructions executable to measure a phase and a gain of each of the plurality of radiating elements; determine a feed gain and a feed phase for each of the plurality of radiating elements based on the measured phase and the measured gain of a respective radiating element; and independently set each of the plurality of radiating elements based on the determined feed gain and the feed phase.

### BRIEF DESCRIPTION OF THE DRAWINGS

The subject matter disclosed herein is particularly pointed out and distinctly claimed in the claims at the conclusion of the specification. The foregoing and other objects, features, and advantages of the aspects disclosed herein will be apparent from the following detailed description taken in conjunction with the accompanying drawings.

FIG. 1 is a diagram illustrating a RF module with an array of active antennas.

FIG. 2 is a diagram illustrating signal propagation in a conventional implementation of phased-array antennas.

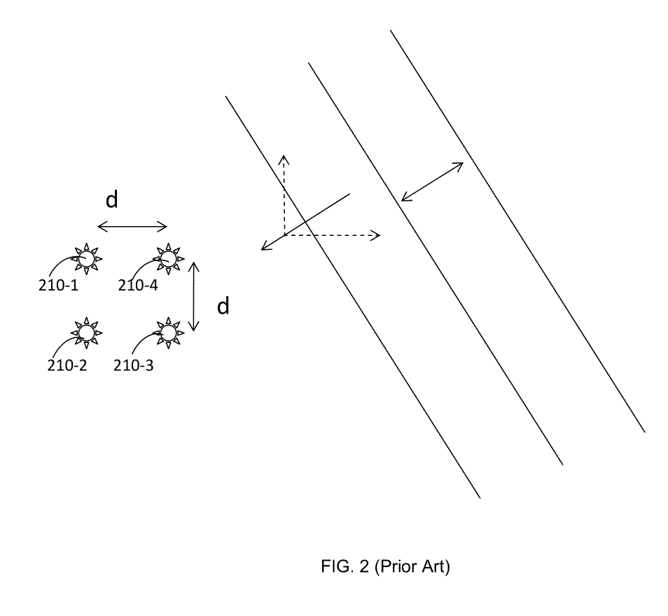

FIG. 3 is a diagram illustrating a radiation pattern of a RFIC constructed according to one aspect.

FIG. 4 is a cross-section diagram of the RFIC illustrating the arrangement of the antenna arrays according to one aspect.

FIG. 5 is a schematic diagram phased-array antenna utilized to describe the various disclosed aspects.

FIG. 6 is a flowchart illustrating utilization of adjustable feed gains of non-identical elements according to an aspect.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein, one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or in place of one or more of the aspects set forth herein. Furthermore, any aspect disclosed herein may be embodied by one or more elements of a claim.

As an example of the above, in some aspects, a method for operating a phased-array antenna may comprise measuring a phase and a gain of each of a plurality of radiating elements of the phased-array antenna, determining a feed gain and a feed phase for each of the plurality of radiating elements of the phased-array antenna based on the measured phase and gain of a respective radiating element and independently setting the feed gain and the feed phase of each of the plurality of radiating elements of the phased-array antenna. In addition, in some aspects, each of the plurality of radiating elements of the phased-array antenna is different.

The aspects disclosed are examples of the many possible advantageous uses and implementations of the innovative teachings presented herein. In general, statements made in the specification of the application do not necessarily limit any of the various disclosed aspects. Moreover, some statements may apply to some inventive features but not to others. In general, unless otherwise indicated, singular elements may be in plural and vice versa with no loss of generality. In the drawings, like numerals refer to like parts through several views.

The proposed aspects avoid the disadvantages of prior art solutions for operating phased-array antennas by controlling non-identical antenna elements of an antenna array. Such aspects permit efficient performance of the underlying unequal array by further customizing the direction and power applied to each independent element.

According to various aspects disclosed herein, non-identical antenna elements of an array of antennas are independently operated to provide good coverage in all directions with various polarizations. The disclosed techniques can be utilized in a RF module having an array of active antennas comprised of a plurality of sub arrays.

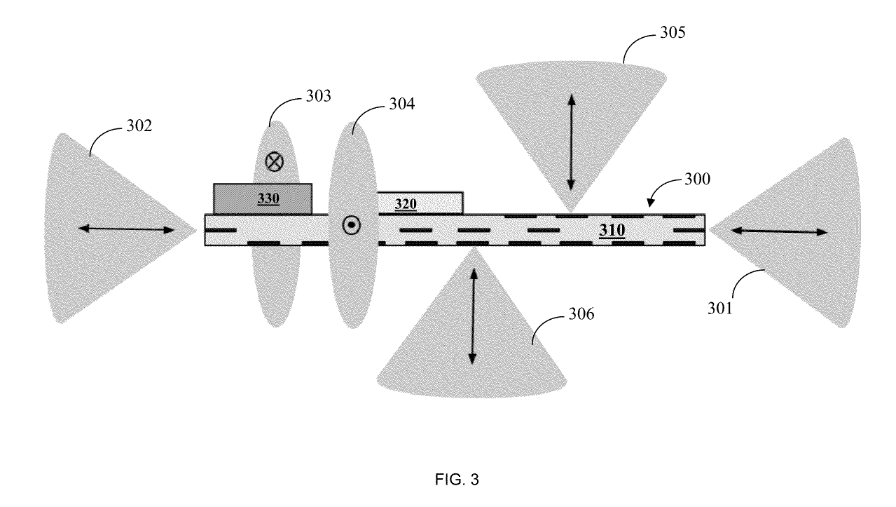

FIG. 3 semantically illustrates the radiation patterns of a RF module 300 that can be utilized to carry out the disclosed aspects. The RF module 300 packages at least the six antenna sub-arrays (not labeled in FIG. 3), an RF circuitry (e.g., in a form of an integrated circuit) 320, and discrete electronic components 330, all of which are fabricated on a multilayer substrate 310 of the RF module 300. The sub-array of antennas that form the active antenna array of the module 300 are designed to receive and transmit millimeter wave signals that propagate from four sides 301, 302, 303, and 304 of the RF module 300. In addition, signals can propagate upward through the upper surface 305 of the RF module 300 and downward through the bottom surface 306 of the RF module 300.

In one configuration, the RF module 300 is installed in electronic devices to provide millimeter wave applications of the 60 GHz frequency band. Examples for such applications include, but are not limited to, wireless docketing, wireless video transmission, wireless connectivity to storage appliances, and the like. The electronic devices may include, for example, smart phones, mobile phones, tablet computers, access points, access terminals, access gateways, electronic kiosks, laptop computers, and the like.

According to one implementation, each element in each antenna sub-array 310 can be independently controlled by the RF circuitry 320. Such control, as discussed in further detail below, is performed to provide good coverage in all directions with various polarizations. As a result, signals can be received and/or transmitted through any combination of the six antenna sub-arrays in the RF module 300. Consequently, such signals may be received from any combination of directions. For example, both the antenna sub-arrays in the upper and bottom layers of the substrate 310 are needed to allow reception and transmission of signals through upward and downward directions, and so on. As will be described below, each radiating element in any of the antenna sub-arrays can be independently controlled to further improve and optimize the antenna array in the module 300. It should be noted that each antenna sub-array is configured to transmit and receive millimeter wave signals. In one aspect, each antenna sub-array is configured to transmit and receive radio signals at the 60 GHz frequency band.

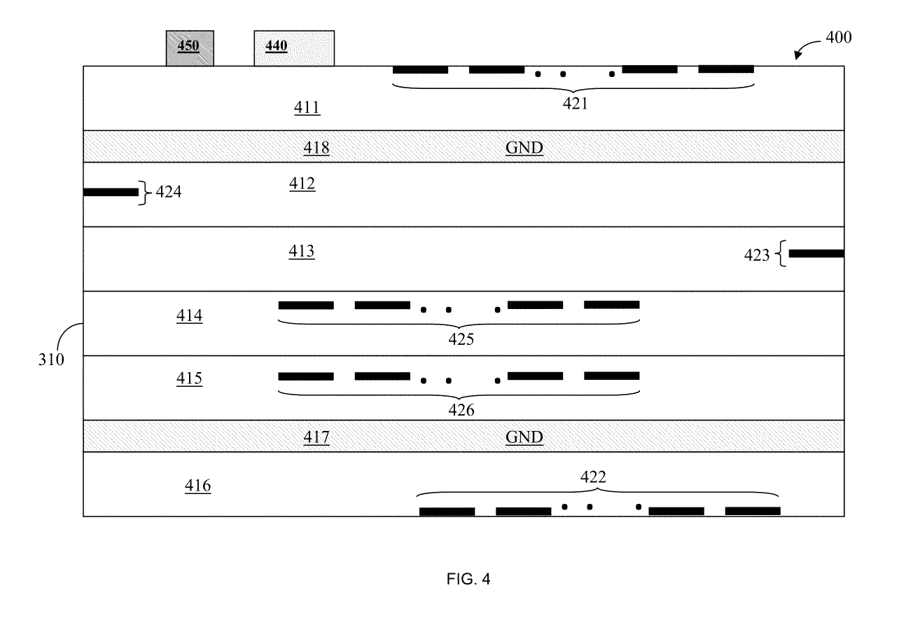

FIG. 4 shows a cross-section diagram of the RF module 300 illustrating the arrangement of the antenna arrays according to one aspect. As illustrated in FIG. 4, the multi-layer substrate 310 of the RF module 300 contains six antenna sub-arrays 421, 422, 423, 424, 425, and 426, which comprise the active antenna array of the module and are implemented on different layers of the multi-layer substrate 310. The sample multi-layer substrate 310 includes 8 layers 411 through 418. Each such layer includes sub-layers of dialectic, metal, and semiconductor materials that adhere to each other.

Specifically, the antenna sub-array 421 is implemented (e.g., printed or fabricated) on a front layer 411 of the substrate 310 and radiates in an upward direction (305). The antenna sub-array 422 is implemented in the back layer 416 of the substrate 310 and radiates at a downward direction (306). The antenna sub-arrays 423, 424, 425, and 426 are implemented in any middle layer of the 412, 413, 414, and 415 of the substrate 310.

In one aspect, each of the antenna sub-arrays 423, 424, 425, and 426 are implemented at a different layer of the middle layers 412, 413, 414, and 415. In another aspect, two or more of the antenna sub-arrays 423, 424, 425, and 426 can share the same layer of the middle layers 412, 413, 414, and 415. In one sample configuration, antenna sub-arrays 423, 424, 425, and 426 radiate through sides 301, 302, 303, and 304 of the RF module 300, respectively.

In the semantic diagram shown in FIG. 4, layers 417 and 418 are ground layers of the RF module 300. In one aspect, all antenna sub-arrays share the ground layers 417 and 418. This sharing of ground layers allows the RF module 300 to maintain a compact stack-up and to shorten the vertical signal routing, thereby reducing the signal losses through the various antenna arrays.

Each of the antenna sub-arrays 421, 422, 423, 424, 425, and 426 can be an active antenna, such as a phased array antenna, in which each radiating element can be controlled independently to enable the usage of beam-forming techniques. In addition, the active antenna may be a phased array antenna in which each radiating element can be controlled individually and independently to enable the usage of beam-forming techniques. In a particular aspect, each of the antenna sub-arrays 421, 422, 423, 424, 425, and 426 can be utilized to receive and transmit millimeter wave signals in the 60 GHz frequency band. As will be described in detail below, the radiating elements of the “side” antenna sub-arrays 423, 424, 425, and 426 are typically constructed differently than the radiating elements of the antenna sub-arrays 421 and 422 of the front and back layers (411, 416).

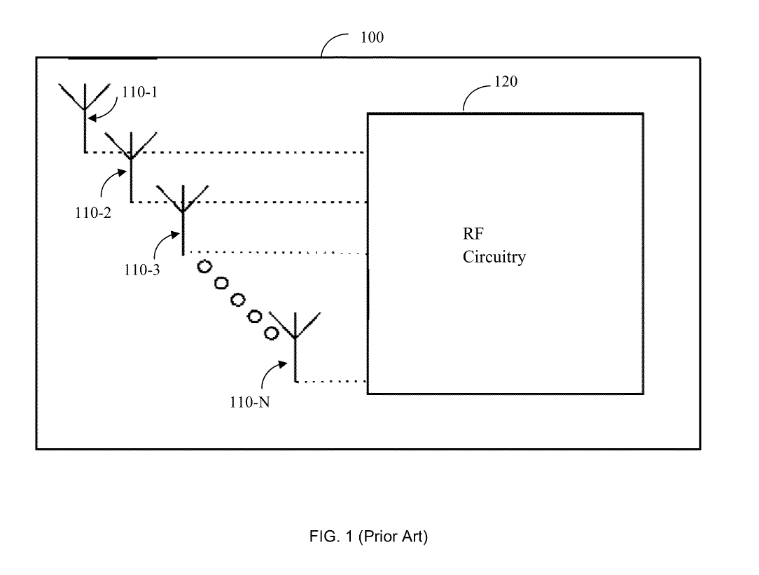

As depicted in FIG. 4, the RF circuitry (RFIC) 440 and discrete electronic components 450 may also be implemented on the multi-layer substrate 310. The RF circuitry 440 typically performs up-conversion using a mixer (not shown in FIG. 1) to convert intermediate frequency (IF) signals to radio frequency (RF) signals. Then, the RF circuitry 440 transmits the RF signals through the TX antenna according to the control of the control signal.

In the receive mode, the RF circuitry 440 receives RF signals through the active RX antenna and performs down-conversion, using a mixer, to IF signals using the local oscillator (LO) signals, and sends the IF signals to a baseband module. In addition, according to one aspect, the RF circuitry 440 can control the antenna sub-arrays 421, 422, 423, 424, 425, and 426 independently of each other. This independent control allows for achieving higher antenna diversity and optimal coverage at a specific direction.

As a non-limiting example, the RF circuitry 440 can switch on the antenna sub-array 421 while switching off the other antenna arrays and/or switching on the side antenna arrays, and so on. It should be noted that, in addition to independently controlling each antenna sub-array, the radiating elements in each antenna sub-array can also be independently controlled. The RF circuitry 440 also controls the phase per antenna in order to establish the beam-forming operation for the phased array antenna.

The discrete electronic components 450 include the components described above. In one aspect, the RF circuitry 440 components 450 are packaged inside a metal shield (not shown) of the RF module 300. The metal shield adheres to the front layer 411, such that the RF circuitry 440 components 450 are also mounted on the front layer. It should be appreciated that the arrangement of the antenna sub-arrays 421-426 enable maximizing the number of antennas and, therefore, the size of the active antenna array in a millimeter wave RF module, without increasing the area of the RF module. Thus, in aspects featuring such an arrangement, the area of the RF module may be kept minimal in spite of the increased number of antennas.

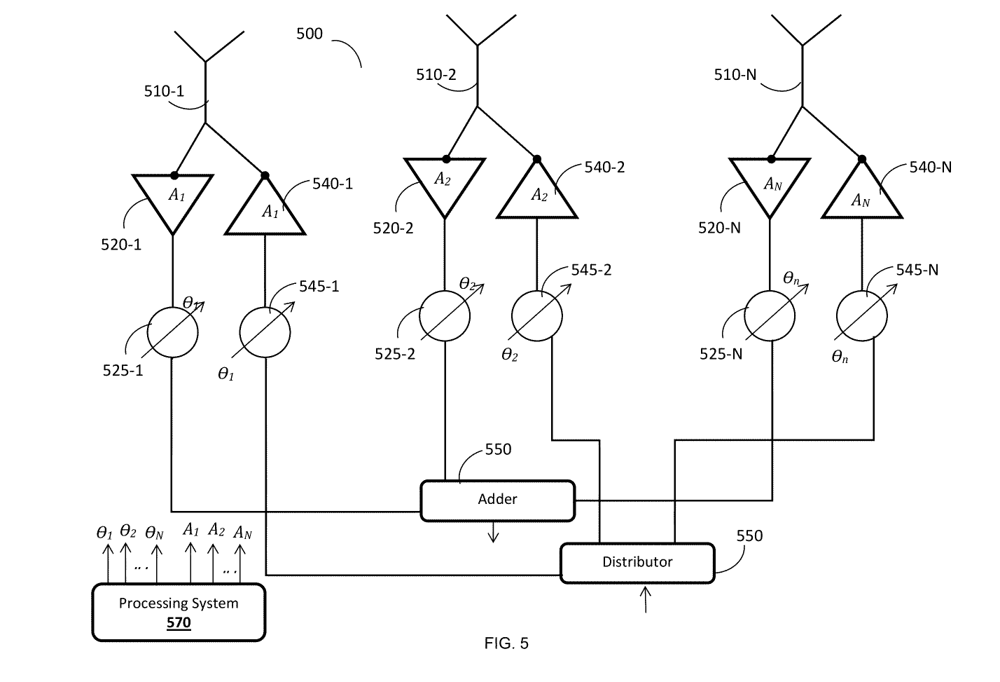

FIG. 5 is a diagram of a phased-array antenna 500 utilized to describe the various disclosed aspects. In one aspect, the antenna 500 may be any of the antenna sub-arrays 421-426 discussed hereinabove with respect to FIG. 4. In another aspect, the antenna 500 may contain the one or more of the six sub-arrays, thereby serving as an active antenna array of the RF module.

The phased-array antenna 500 includes a number N of radiating elements 510-1 through 510-N, each of which is designed to receive and transmit mm-wave signals, for example, over the 60 GHz frequency band. It should be noted that the different sub-arrays 421-426 forming the antenna 500 as well as the radiating elements 510-1 through 510-N can be constructed using different type of antenna elements. For example, a first set of radiating elements can be dipole, while a second set of radiating elements may be Yagi-Uda.

In the receive direction, each of the radiating elements 510-1 through 510-N is respectively connected to a LNA 520-1 through 520-N (hereinafter referred to collectively as LNAs 520 or individually as a Low-noise amplifier (LNA) 520, merely for the sake of simplicity and without restriction on the disclosed aspects) and a phase shifter 525-1 through 525-N (hereinafter referred to collectively as phase shifters 525 or individually as a phase shifter 525, merely for the sake of simplicity and without restriction on the disclosed aspects), and is further connected to an adder component 550 that sums the received signals.

In the transmit direction, each of the radiating elements 510-1 through 510-N is respectively connected to a power amplifier (PA) 540-1 through 540-N (hereinafter referred to collectively as power amplifiers 540 or individually as a power amplifier 540, merely for the sake of simplicity and without restriction on the disclosed aspects) and to a phase shifter 545-1 through 545-N (hereinafter referred to collectively as phase shifters 545 or individually as a phase shifter 545), and is further connected to a distributor 560 that distributes an incoming RF signal to the radiating elements.

According to the disclosed aspects, the phase θi of each phase shifter 525 or 545 are individually or independently controlled during the reception or transmission of signals. In addition, the gain Ai of each of the LNAs 520 or PAs 540 are independently controlled during the reception or transmission of signals. Thus, according to the disclosed aspects, the gains and phases (Ai; θi, i=1, . . . , N) of the signal feeds to the elements are individual controlled, thereby optimizing the performance for the phased-array antenna 500 in all directions and all polarizations.

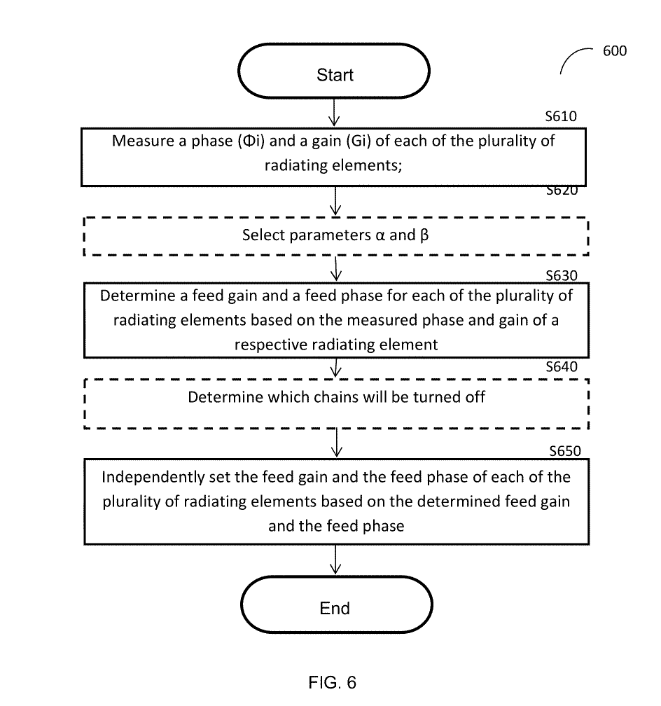

In an aspect, the controllable components, i.e., the amplifiers 520 and 540 and the phase shifters 525 and 545 are controlled by a processing system 570. The processing system 570 is configured to operate the antenna 500 by adjusting feed gains and phases of the elements 510. The various aspects for controlling the gain and phase (Ai; θi) as the function of the direction and polarization and other implementation dependent aspects are discussed in greater detail herein below with respect to FIG. 6.

The processing system 570 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system 570 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

In one aspect, the processing system 570 may be integrated in the RF circuitry (for example, RF circuitry 440, FIG. 4). In another aspect, the processing system 570 may be part of a baseband module (not shown).

In certain aspects, the radiating elements 510-1 through 510-N are based on balanced-feed antennas, such as dipole antennas or Yagi-Uda antennas. Typically, balanced-feed antennas are coupled to a “balun” element that generates the balanced (differential) signals from an input signal to be transmitted. The receive operation is reciprocal, i.e., the antenna generates balanced signals which are combined to a single line via balanced to unbalanced transition.

According to the disclosed aspects, the phase shifters 525 and 545 can be set to perform the balun function. That is, the phase shifters 525 and 545 may be set to generate balanced differential signals by setting a 180 degrees phase difference between two feeds (not shown in FIG. 5) of the antenna element. Specifically, when a balun function is required, the phase feed of a first feed is set to θi while the phase feed of the other feed is set to θi+180°. It should be appreciated that, in this aspect, there is no need for an explicit balun as part of the RF module design.

FIG. 6 is a flowchart 600 illustrating a method for operating the phased-array antenna 500 according to one aspect. The method adjusts feed gains and phases of non-identical and non-balanced radiating elements.

In S610, the gain Gi and phase φi of each radiating element 510 are measured. In one aspect, the measurement is performed during a beam forming process. In order to measure the gain Gi and phase φi, a transmitter continuously transmits a (repeated sequence) signal to the receiver having the phased-array antenna (e.g., antenna 500) to be controlled. The gains Gi and phases φi may be measured as functions of the physical direction D and polarization of the other side of the communication link. The physical direction D and polarization varies due to movements and rotations in either the transmitter or receiver.

The receiver turns on one radiating element (e.g., element 510-1) and turns off the other radiating elements (e.g., elements 510-2 through 510-N). This is performed for each radiating element. For each element that is on, the receiver measures the phase and the amplitude of the received signals. The measured information serves as the gain Gi and phase φi of the respective element. In one aspect, the measured gain Gi and phase φi for all elements are saved in the controller 570. In addition, these measurements can be sent to the transmitter as well.

A sample process for measuring the gain Gi and phase φi is also discussed in the PHY/MAC specification of the IEEE 802.11ad standard (also known as WiGi), approved and published on May 20, 2010. In one aspect, the gain Gi and phase φi are utilized in controlling the feed of the respective element during reception or transmission of the signals.

In S620, two configurable parameters α and β are selected. The parameters α and β are used in the calculation of the feed gain and phase Ai and θi, which are proportional to the measured antenna gain Gi and phase φi. In one aspect, the values of α and β are randomly selected. In another aspect, the values of α and β are determined to minimize the phase quantization error. Typically, the accuracy of beam steering and other properties of the radiation pattern depend on the phase feeding of the radiating elements. The phase quantization error affects the phase feeding, and reducing this error allows for improved antenna performance.

In one aspect, the α and β values are set to a range of preconfigured values, and the phase quantization error is measured. The set of α and β values that provide the minimal error is selected.

In S630, the feed gain and phase for each radiating element (Ai; θi, i=1, . . . , N) are individually determined based on the parameters and the measured antenna gain and phase (Gi; φi, i=1, . . . , N). In one aspect, the feed gain and phase are determined using the configurable parameters α and β.

In one aspect, individual element feed gain and phase values Ai; θi may be determined to be proportional to the feed gain and phase for the array. In one aspect, the optimal values for array feed gain Ai and phase θi may be determined as a function of direction. This determination may be accomplished by, e.g., using predetermined equations such as equations 1 and 2, as shown below:

Ai=∝Gi Equation 1

θi=−φ+β Equation 2

The Gi, φi, α, and β are as defined above.

The feed gain and phase computed using the equations 1 and 2 shown above provide an optimal assignment in terms of maximal power efficiency in the transmitter and minimum noise at the receiver. In one aspect, the phases can be observed by the following inequality:

|Σᵢ₌₀^{N}Ai·Gi·e^{j(θi+φi)}|≦|Σᵢ₌₀^{N}Ai·Gi| Equation 3

Equation 3 reaches equality when θi=−φi+β.

Another aspect to set the values of Ai and θi can be determined using the following equation:

$$\vert {\sum }_{i = 0}^{N} Ai \cdot Gi \vert \leq \sqrt{{\sum }_{i = 0}^{N} {\vert Ai \vert}^{2} \cdot {\sum }_{i = 0}^{N} {\vert Gi \vert}^{2}} \qquad Equation 4$$

Equation 4 reaches equality if Ai=∝Gi. In an aspect, setting the array gains using Equation 3 or Equation 4 minimizes the side-lobes. In another aspect, the side-lobes of the radiating elements can be minimized by, for example, non-convex optimization algorithms. Such algorithms can maximize the gain for the required direction while minimizing other directions or nullifying other specific directions. The operation of the non-convex optimization and similar algorithms is effective because the radiating elements (510) are different and, thus, their respective gain Gi values are different. In addition, the feed gains Ai are independently controlled.

In another aspect, the values for feed gain Ai and phase θi may be determined to be the closest possible values to the optimal values. The closest possible optimal value of θi may be determined based on:

$$arg {max}_{\{ θ i ∈ [ 0 , 90 , 180 , 270 ] \}} \vert {\sum }_{i = 0}^{N} Ai \cdot Gi \cdot {e}^{j ( i ∓ Φ i )} \vert \qquad Equation 5$$

The closest possible optimal value of Ai may be determined as follows:

$$arg {max}_{\{ Ai ∈ [ {10}^{0} , {10}^{- 0.2} , {10}^{- 0.4} , {10}^{- 0.6} , {10}^{- 8} , 0 ] \}} \vert {\sum }_{i = 0}^{N} Ai \cdot Gi \cdot {e}^{j ( θ i ∓ Φ i )} \vert \qquad Equation 6$$

In one aspect, a Monte-Carlo method or exhaustive search can be used to solve Equation 5, Equation 6, or both.

In such an aspect, if the implemented control is inefficient or cannot otherwise achieve the optimal values for feed gain Ai and phase θi, the values for feed gain Ai and phase θi may be determined to be the closest possible values to the optimal values. Such inability to achieve optimal values may occur due to, e.g., control quantization, amplifier structure, gain mismatches in a chain, and so on.

In yet another aspect, to conserve power, one or more complete chains in the array may be turned off. Preferably, such turned off chains are the chains with the lowest gain values Gi. Turning off certain chains with lower gain allows conserving power while minimally degrading performance. In such an aspect, in S640, it is determined which chain or chains will be turned off. The chains that will be turned off may be determined by, but not limited to, a predetermined number of chains with the lowest gain values Gi, any number of chains with total gain value below a threshold value, and so on.

In yet another aspect, the feed gain Ai in any or all of the elements may be modified by changing the arbitrary gain constant α for the modified elements. This modification may occur by, e.g., changing the amplification of the element's gain. In such an aspect, lowering the parameter α will lower power consumption in the array because amplifiers tend to consume less power for lower gain values.

In S650, the gain and phase of each element in the array are independently set based on each element's feed gain value Ai and phase value θi. It should be noted that, in all of the above aspects, when a balun function should be implemented, one of the antenna's feeds is set to θi, while the other is set to θi+180°.

It is important to note that these aspects are examples of the many advantageous uses of the innovative teachings herein. Specifically, the innovative teachings disclosed herein can be adapted in any type of consumer electronic device where reception and transmission of millimeter wave signals is needed. Moreover, some statements may apply to some inventive features but not to others. In general, unless otherwise indicated, it is to be understood that singular elements may be in plural and vice versa with no loss of generality.

The various components and functions represented described herein, may be implemented using any suitable means. Such means are implemented, at least in part, using corresponding structure as taught herein. For example, the components described above in conjunction with the processing system 570 correspond to similarly designated “means for” functionality. Thus, one or more of such means is implemented using one or more of processor components, integrated circuits, or other suitable structure as taught herein in some implementations.

In some implementations, a communication device structure such as a transceiver or a RF module is configured to embody the functionality of a means for receiving and transmitting any signals, such as millimeter wave signals. For example, in some implementations, this structure is programmed or designed to receive and process any signals received as a result of the receive operation. In addition, in some implementations, this structure is programmed or designed to process and transmit any signals transmitted as a result of the transmit operation. Typically, the communication device structure comprises a wireless-based transceiver device.

In some implementations, a processing system structure, such as an ASIC or a programmable processor, is configured to embody the functionality of a means for measuring the gain and phase of each radiating element. In some implementations, this structure is further programmed or designed to determine the feed gain and phase of each radiating element based on the respective measured gain and phase of each radiating element. In some implementations, this structure is further programmed or designed to independently set the feed gain and phase of each radiating element.

The steps of a method or algorithm described in connection with the aspects disclosed herein may be embodied directly in hardware, in a software module executed by a processor, or in a combination of the two. A software module (e.g., including executable instructions and related data) and other data may reside in a memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising code executable (e.g., executable by at least one computer) to provide functionality relating to one or more of the aspects of the disclosure. In some aspects, a computer program product may comprise packaging materials. Furthermore, a non-transitory computer readable medium is any computer readable medium except for a transitory propagating signal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A computer-readable media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer-readable medium (e.g., tangible media, computer-readable storage medium, computer-readable storage device, etc.). Such a non-transitory computer-readable medium (e.g., computer-readable storage device) may comprise any of the tangible forms of media described herein or otherwise known (e.g., a memory device, a media disk, etc.). In addition, in some aspects computer-readable medium may comprise transitory computer readable medium (e.g., comprising a signal). Combinations of the above should also be included within the scope of computer-readable media. It should be appreciated that a computer-readable medium may be implemented in any suitable computer-program product. Although particular aspects are described herein, many variations and permutations of these aspects fall within the scope of the disclosure.

Also, it should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise a set of elements comprises one or more elements. In addition, terminology of the form “at least one of A, B, or C” or “one or more of A, B, or C” or “at least one of the group consisting of A, B, and C” or “at least one of A, B, and C” used in the description or the claims means “A or B or C or any combination of these elements.” For example, this terminology may include A, or B, or C, or A and B, or A and C, or A and B and C, or 2A, or 2B, or 2C, and so on.

Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the description.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. A method for operating a plurality of radiating elements, comprising:
measuring a phase and a gain of each of the plurality of radiating elements;
determining a feed gain and a feed phase for each of the plurality of radiating elements based on the measured phase and the measured gain of a respective radiating element; and
setting independently each of the plurality of radiating elements based on the determined feed gain and the feed phase.

2. The method of claim 1, wherein each of the plurality of radiating elements is different.

3. The method of claim 1, wherein the gain and the phase of each of the plurality of radiating elements are measured as a function of a specific direction and rotation.

4. The method of claim 1, wherein each feed gain is proportional to the measured gain and each feed phase has opposite polarity to the measured phase of each respective radiating element.

5. The method of claim 1, wherein the determination comprises:
setting the feed gain (Ai) to Ai=∝Gi and the feed phase (θi) to θi=−φi+β, wherein ∝ and β are configurable parameters and Gi and φi are the measured gain and the measured phase of the respective radiating element, respectively.

6. The method of claim 5, further comprising:
randomly selecting values of the configurable parameters.

7. The method of claim 5, further comprising:
selecting values for the configurable parameters based on a quantization error associated with either transmission of radio signals or reception of radio signals.

8. The method of claim 1, wherein each of the radiating elements comprises first and second feeds and wherein the determination comprises:
setting a phase difference between the first and second feeds to 180 degrees.

9. The method of claim 1, wherein each of the radiating elements transmits and receives signals in a 60 GHz or higher frequency band.

10. The method of claim 1, further comprising:
arranging the plurality of radiating elements in at least one of: a front antenna sub-array, a back antenna sub-array, or one or more middle antenna sub-arrays.

11. An apparatus for communication, comprising:
a plurality of radiating elements; and
a processing system configured to:
measure a phase and a gain of each of the plurality of radiating elements;
determine a feed gain and a feed phase for each of the plurality of radiating elements based on the measured phase and gain of a respective radiating element; and
independently set the feed gain and the feed phase of each of the plurality of radiating elements based on the determined feed gain and the feed phase.

12. The apparatus of claim 11, wherein each of the plurality of radiating elements is different.

13. The apparatus of claim 11, wherein the gain and the phase of each of the plurality of radiating elements are measured as a function of a specific direction and rotation.

14. The apparatus of claim 11, wherein each feed gain is proportional to the measured gain and each feed phase has opposite polarity to the measured phase of each respective radiating element.

15. The apparatus of claim 11, wherein processing system is further configured to set the feed gain (Ai) to Ai=∝*Gi; and the feed phase (θi) to θ=−φi+β, wherein ∝ and β are configurable parameters, and Gi and φi are the measured gain and the measured phase of the respective radiating element, respectively.

16. The apparatus of claim 15, wherein the processing system is further configured to randomly select values of the configurable parameters.

17. The apparatus of claim 15, wherein the processing system is further configured to select values for the configurable parameters based on a quantization error associated with either transmission or reception of radio signals.

18. The apparatus of claim 11, wherein each of the radiating elements comprises first and second feeds and wherein the processing system is further configured to set a phase difference between the first and second feeds to 180 degrees.

19. The apparatus of claim 11, wherein each of the radiating elements transmits and receives signals in a 60 GHz or higher frequency band.

20. The apparatus of claim 11, wherein the plurality of radiating elements are arranged in at least one of: a front antenna sub-array, a back antenna sub-array, or one or more middle antenna sub-arrays.

21. A computer program product comprising a computer-readable medium having instructions executable by an apparatus to:
measure a phase and a gain of each of the plurality of radiating elements;
determine a feed gain and a feed phase for each of the plurality of radiating elements based on the measured phase and the measured gain of a respective radiating element; and
independently set each of the plurality of radiating elements based on the determined feed gain and the feed phase.

22. An apparatus for operating a plurality of radiating elements comprising:
means for measuring a phase and a gain of each of the plurality of radiating elements;
means for determining a feed gain and a feed phase for each of the plurality of radiating elements based on the measured phase and the measured gain of a respective radiating element; and
means for independently setting each of the plurality of radiating elements based on the determined feed gain and the feed phase.

23. An access terminal comprising:
a plurality of radiating elements;
a processing system configured to:
measure a phase and a gain of each of the plurality of radiating elements;
determine a feed gain and a feed phase for each of the plurality of radiating elements based on the measured phase and the measured gain of a respective radiating element; and
independently set each of the plurality of radiating elements based on the determined feed gain and the feed phase; and
a transmitter configured to transmit signals via the set radiating elements.
